(19) United States
(12) Patent Application Publication
(10) Pub. No.: US 2026/0104078 A1
(43) Pub. Date: Apr. 16, 2026

(54) METHOD FOR PRODUCING A BRAKE DISC

(71) Applicant: Breyden GmbH, Breidenbach (DE)

(72) Inventors: Christian Alexander Bellinghausen, Driedorf (DE); Ingo Barzen, Remscheid (DE); Kilian Schreiner, Gladenbach (DE); Johannes Glowatzki, Gladenbach (DE); Frank Feussner, Wetter (DE); Thomas Pfeiffer, Steffenberg (DE); Kangjian Wu, Marburg (DE)

(21) Appl. No.: 19/338,034

(22) Filed: Sep. 24, 2025

(30) Foreign Application Priority Data
Oct. 16, 2024 (DE) 10 2024 129 996.7

(51) Int. Cl. F16D 65/12; B22F 7/08; B22F 10/66; B33Y 10/00; B33Y 40/20; B33Y 80/00; F16D 65/02

(52) U.S. Cl. CPC F16D 65/127; B22F 7/08; B22F 10/66; B33Y 10/00; B33Y 40/20; B33Y 80/00; F16D 2065/132

(57) ABSTRACT

A method for producing a brake disc that includes a metal base body with a hub fastening and a metal friction ring is described. The hub fastening provides an annular bub contact surface, and the friction ring has two opposing annular friction surfaces arranged around the rotational axis of the base body. The base body is cast from metal, after which material may be removed from the friction surfaces and/or the hub contact surface so that the friction surfaces exhibit a defined radial gradient relative to the hub contact surface. A wear-protection layer is then applied to one or both friction surfaces. Thermal stresses generated during this coating process deform the friction surfaces such that the magnitude of the initial radial gradient is reduced, resulting in a smaller residual gradient.

### CROSS-REFERENCE TO RELATED APPLICATION

This application claims the benefit of and priority to Germany (DE) Patent Application No. 10 2024 129 996.7 filed Oct. 16, 2024, the contents of which being incorporated by reference in their entirety herein.

### TECHNICAL FIELD

The invention relates to a method for producing a brake disc.

### BACKGROUND

Brake discs, in particular brake discs made of grey cast iron, are known in the related art. These brake discs have a base body with a friction ring, wherein the friction ring has two opposite annular friction surfaces. In order to improve the wear behaviour of the base body manufactured from grey cast iron, it is known to provide the two friction surfaces with a wear protection layer which is applied by laser metal deposition and guarantees a high mileage of the manufactured brake disc. In this process, the outer surface of each friction surface to be coated is melted by means of a laser beam and, at the same time, at least one coating powder is fed onto the melted friction surface, this coating powder being at least partially liquefied by the laser beam before reaching the melted friction surface, so that a material connection is produced between the friction surface and the coating powder, thus producing the wear protection layer. As a result of the material bond, the wear protection layer applied by means of laser metal deposition has a high degree of coating adhesion and resistance to delamination. Corresponding brake discs are described, for example, in EP 3 034 902 A1, DE 10 2019 207 291 A1 and DE 10 2021 104 237 A1.

A disadvantage of laser metal deposition is a change in the geometry of the brake disc due to the high heat input. During laser metal deposition, due to thermally induced stress, the friction ring of the base body becomes distorted either in the direction of the friction surface on the outer side or in the direction of the friction surface on the inner side of the brake disc, depending on the order in which the friction surfaces are coated. Moreover, after laser metal deposition, the wear protection layer has a high degree of surface roughness of up to 100 μm. The wear protection layer is therefore smoothed in the next process step, for example by means of grinding, in particular in such a way that the friction surfaces are oriented orthogonally to the axis of rotation of the brake disc. The distortion of the friction ring after laser metal deposition leads to the disadvantage during smoothing that the layer thickness of the wear protection layer varies greatly in the radial direction. Compensating for the distortion during smoothing removes the wear protection layer to greatly different extents in the radial direction.

In order to reduce the distortion of the base body, DE 10 2020 112 100 A1 proposes preheating the base body to a temperature of between 100° C. and 700° C. before laser metal deposition. However, a disadvantage of preheating the grey cast iron base body is the additional process step, which involves additional energy, costs and time. Furthermore, the two friction surfaces of the friction ring may oxidize as a result of preheating, which impairs the adhesion between the friction ring and the wear protection layer.

### BRIEF SUMMARY

The object of the disclosure is to provide a brake disc and/or a method for producing a brake disc, with which a wear protection layer is provided on the friction surfaces with a homogeneous coating thickness, this wear protection layer also having a high degree of coating adhesion and resistance to delamination. The production process should be reliable and cost-effective to perform, so that the brake discs are also cost-effective to manufacture.

Features according to the invention are specified in Claim 1. Refinements are the subject matter of Claims 2 to 11.

### BRIEF DESCRIPTION OF THE FIGURES

FIG. 1a shows a schematic illustration of a brake disc after prefabrication of a base body according to the prior art;

FIG. 1b shows a schematic illustration of the brake disc according to FIG. 1a after the creation of a wear protection layer on the friction surfaces;

FIG. 1c shows a schematic illustration of the brake disc according to FIG. 1b after smoothing of the friction surfaces;

FIG. 2a shows a schematic illustration of a brake disc after prefabrication of a base body according to the invention;

FIG. 2b shows a schematic illustration of the brake disc according to FIG. 2a after the creation of a wear protection layer on the friction surfaces; and

FIG. 2c shows a schematic illustration of the brake disc according to FIG. 2b after smoothing of the friction surfaces.

### DETAILED DESCRIPTION

The disclosure relates to a method for producing a brake disc, in particular a coated brake disc, comprising (a) prefabricating a base body with a hub fastening and with a friction ring made of metal, in particular grey cast iron, wherein the hub fastening has an annular hub contact surface, wherein the friction ring has two opposite annular friction surfaces, which run around an axis of rotation of the base body, by casting the base body from metal, and by optionally removing material in the region of the friction surfaces and/or in the region of the hub contact surface after casting, in such a way that the annular friction surfaces have a radial gradient with respect to the hub contact surface. This is followed by (b) creating a wear protection layer on one or on both of the friction surfaces in such a way that stresses thermally induced in this process deform the annular friction surfaces in such a way that an absolute value of the radial gradient is reduced to a lower absolute value of a radial residual gradient.

The advantage of this is that it is not necessary to perform an additional process step such as the known preheating step. The method is accordingly safe, rapid and cost-effective. Oxidation of the base body and impairment of the adhesion of the wear protection layer, as with preheating, is ruled out. Any distortion problems, as with laser metal deposition, can be effectively remedied. Since the radial gradient acts to achieve a lower residual gradient, the brake disc already has highly accurate dimensions after the creation of the wear protection layer. Any material-removing finishing of the friction surfaces can be carried out more homogeneously, so that a homogeneous layer thickness of the wear protection layer remains. By defining the absolute values of the gradient, the process case in which the friction surfaces deform to such an extent that the sign of the gradient changes is also included.

From a technical perspective, the radial gradient can be produced by optionally removing material in the region of the friction surfaces, or else additionally or alternatively in the region of the hub contact surface.

According to a more detailed refinement of the method, it is provided that, after the creation of the wear protection layer, the radial residual gradient is substantially or completely zero degrees (in particular with respect to the hub contact surface), so that the friction surfaces, in particular in the installed state of the brake disc, are oriented at least substantially or completely orthogonally to the axis of rotation. This eliminates the need for finishing to correct the geometry of the friction surfaces. Any finishing can be limited at least substantially to adaptation of the surface roughness.

Specifically, it may be provided that the friction surfaces each have a ring width with an inner radius and an outer radius, wherein, during prefabrication of the base body, the radial gradient of the friction surfaces is formed in such a way that, along an orthogonal axis to the hub contact surface, the inner radius has an offset to the outer radius, the absolute value of the offset being between 10 μm and 90 μm, optionally between 30 μm and 70 μm. The radial gradient formed in this way is generally sufficient in practice to compensate for the thermal distortion during the creation of the wear protection layer.

Furthermore, it may be provided according to the method that the friction surfaces each have a ring width with an inner radius and an outer radius, wherein, after the creation of the wear protection layer, the radial residual gradient is formed in such a way that, in the direction of an axis orthogonal to the hub contact surface, the inner radius has an offset to the outer radius, the absolute value of this offset being less than 50 μm, optionally less than 30 μm. In accordance with the maximum offset, it is necessary in the event of any finishing that the wear protection layer be locally removed by no more than this value in order to obtain a friction surface oriented orthogonally to the axis of rotation.

In a particular refinement of the method, the radial gradient is a constant angle, or the radial gradient is continuous and becomes steeper with increasing distance from the axis A of rotation. These two ways of defining the radial gradient compensate for the two main deformation patterns caused by the creation of the wear protection layer. The constant gradient is suitable in particular if, as a result of the thermally induced stresses, the ring surface tilts over the full ring width, for example because the hub fastening arranged on the inside is deformed. The continuous radial gradient that steepens outwards can compensate for bowl-like deformations over the width of the friction ring.

Optionally, the creation of the wear protection layer comprises a thermal coating process, such as laser metal deposition, in which the wear protection layer is applied to the base body (in particular in the region of the friction surfaces), or the wear protection layer is created on the base body (in particular in the region of the friction surfaces) in a thermal diffusion process such as nitriding.

In some embodiments, the wear protection layer is created by laser metal deposition. This method involves high heat input into the base body, with thermally generated stresses and distortion, which can be compensated according to the method by the radial gradient during prefabrication. During laser metal deposition, the outer surface of the two friction surfaces to be coated should be melted by means of a laser beam and a coating powder should be fed onto the melted friction surface. Optionally, the coating powder is at least partially liquefied by the laser beam before reaching the melted friction surface. Specifically, this produces a material connection between the friction surface and the coating powder and thus produces the wear protection layer.

Optionally, the method may comprise (c) smoothing the friction surfaces, optionally by grinding, after the creation of the wear protection layer, in particular in such a way that the friction surfaces are aligned orthogonally to the axis of rotation. This allows at least the surface roughness to be reduced. In addition, it is possible to level out any misalignment and runouts affecting the friction surfaces.

Specifically, after smoothing, the layer thickness of the wear protection layer on one or on both friction surfaces may have, in each case, a layer thickness variation of less than 50%, optionally of less than 30%, wherein the layer thickness variation is defined in particular by dividing the difference between the maximum and minimum layer thickness by the minimum layer thickness. This provides a largely homogeneous wear layer thickness, which permits a long service life with low fine particulate emissions.

During prefabrication of the base body, the annular friction surfaces should be produced in a rotationally symmetrical manner. In this way, they are closer to the target geometry, wherein no other thermal distortions affecting the circumference are generally to be expected during the creation of the wear protection layer, in particular not during laser metal deposition. Furthermore, the annular friction surfaces should be oriented parallel to each other during prefabrication of the base body. This too renders the friction ring close to the target geometry.

In a method variant, it is provided that, during prefabrication of the base body after casting, the annular friction surfaces and the hub contact surface are oriented at least substantially or completely orthogonally to the axis of rotation, and the radial gradient is increased, or produced exclusively, by the (then obligatory) removal of material in the region of the friction surfaces and/or in the region of the hub contact surface. As a result, the method is readily applicable if casting moulds already exist with orthogonally oriented friction surfaces and hub contact surfaces, since the removal of material can be adapted in a simple manner, in contrast with the process of adapting casting moulds. In addition, adapting the removal of material allows corrections to be made to the radial gradient during manufacturing as part of quality control.

Optionally, the method may comprise checking, in particular measuring (for example with a measuring probe), the radial residual gradient of at least one of the two friction surfaces after the creation of the wear protection layer, and correcting the radial gradient during prefabrication of the next base body in such a way that its friction surfaces, after the creation of the wear protection layer, have an anticipated radial residual gradient which is smaller than the radial residual gradient of the checked friction surface. The advantage of the check is increased process reliability in manufacturing with regard to the radial residual gradient of the friction surfaces. Casting quality and, for example, tool wear during the optional removal of material during prefabrication have an effect on the radial gradient of the friction surfaces during prefabrication. The process parameters for the creation of the wear protection layer may also influence the thermal distortion of the friction surface. Checking the radial residual gradient allows corrections to be made, optionally automatically, by adapting the machine parameters for forming the provided radial gradient in the prefabrication operating step.

Additionally, the method may comprise (a2) creating an intermediate layer on one or both of the friction surfaces before the creation of the wear protection layer. Such an intermediate layer can increase coating adhesion and resistance to delamination.

Further features, details and advantages of the disclosure will be apparent from the wording of the claims and also from the description below of exemplary embodiments with reference to the drawings, in which:

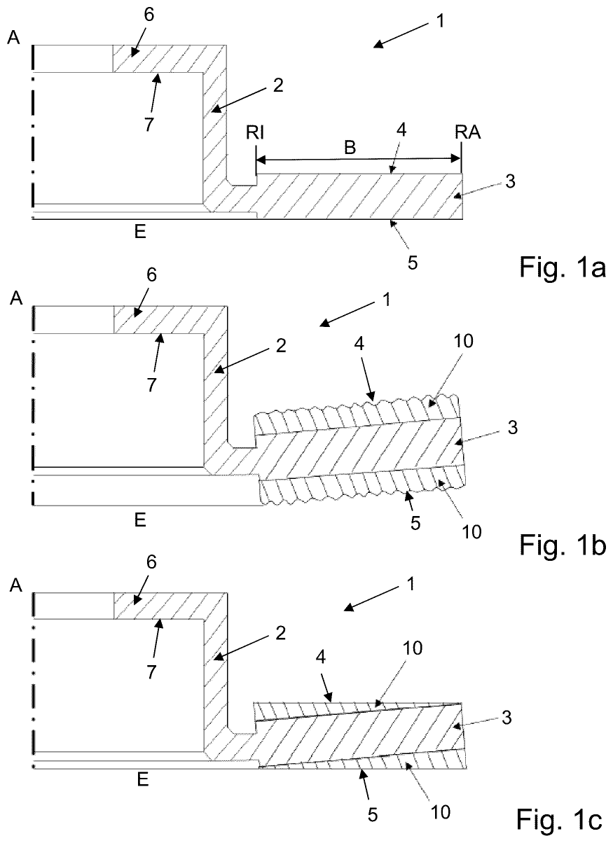

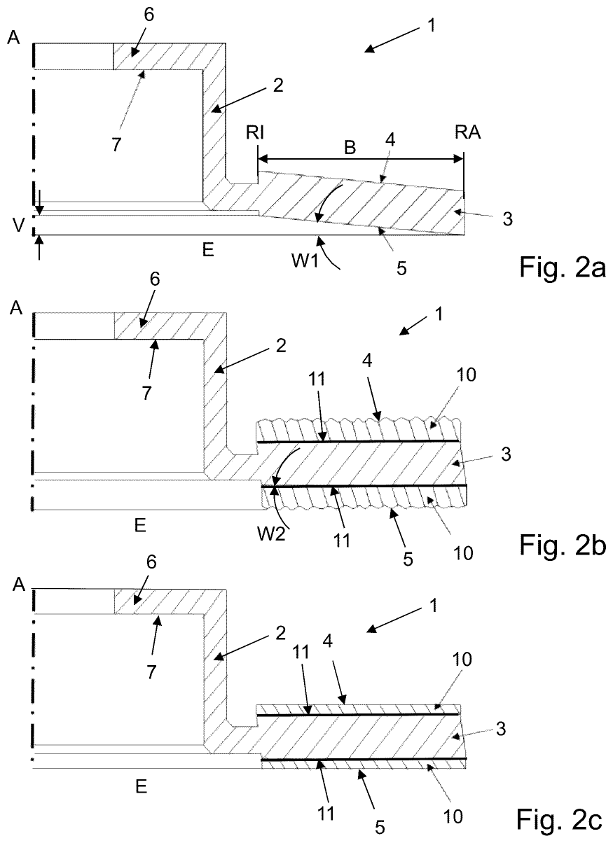

Turning now to the drawings, FIGS. 1a, 1b, 1c, 2a, 2b, 2c each show a schematic illustration of a brake disc 1. A common description of the figures is therefore provided first, wherein the reference numbers refer to the respective corresponding features. The brake disc 1 has a base body 2 with a friction ring 3 made of metal, optionally cast iron. The friction ring 3 has two annular friction surfaces 4, 5, which are located opposite one another in a parallel manner and run in a rotationally symmetrical manner around a (virtual) axis A of rotation of the base body 2. The annular friction surfaces 4, 5 each have a ring width B, which extends between an inner radius RI and an outer radius RA (reference signs in FIGS. 1a and 2a only). The base body 2 has a hub fastening 6 which is formed in one piece with the friction ring 3 and has a hub contact surface 7 oriented orthogonally to the axis A of rotation. The friction ring 3 is thus arranged on the hub fastening 6. A (virtual) plane E is likewise oriented orthogonally to the axis A of rotation.

The base body 2 of the brake disc 1 according to FIG. 1a is produced by casting the base body 2 from metal, and optionally removing material in the region of the friction surfaces 4, 5 in such a way that the annular friction surfaces 4, 5 are oriented orthogonally to the axis A of rotation and/or parallel to the plane E. During the creation of a wear protection layer 10 on the two friction surfaces 4, 5 with a heat-input method, in particular laser metal deposition, the friction ring 3 is deformed, as illustrated in FIG. 1b, due to thermal stresses. The entire friction ring, comprising the friction surfaces 4, 5 and the wear protection layer 10, forms an angle to the plane E. Viewed circumferentially, the friction surfaces could be described as a flat truncated cone lateral surface. Although it is possible to compensate for this angle by smoothing the friction surfaces 4, 5, in particular the wear protection layer 10, in such a way that the friction surfaces 4, 5 are again oriented parallel to the plane E, as shown in FIG. 1c, carrying out, for example, microscopic investigations reveals that the wear protection layer 10, as shown in FIG. 1c, has considerable differences in layer thickness across the friction ring width B. In use, this can result in the wear protection layer 10 already being worn away in the thinner layer thickness region and still being effective in the thicker layer thickness region. This results in increasing fine particulate emissions from the region of grey cast iron of the friction ring 3, even in a relatively early state of wear. In addition, a cooperating brake pad is worn away unevenly, with the result that, over its lifetime, the friction surface 4, 5 begins to tilt relative to the plane E.

According to the disclosure, it is therefore provided in accordance with FIG. 2a that in the production process, the base body 2 with the friction ring 3 made of metal is prefabricated in such a way that, after casting the base body 2 from metal, and optionally removing material in the region of the friction surfaces 4, 5, these friction surfaces 4, 5 have a radial gradient W1 with respect to the hub contact surface 7 (in the exemplary embodiment also with respect to the orthogonal plane E). This radial gradient W1 is selected based on empirical values in such a way that the subsequent creation of the wear protection layer 10 on the two friction surfaces 4, 5, due to the stresses thermally induced in this process, leads to a deformation in such a way that the radial gradient W1 of the friction surfaces 4, 5 is reduced to a radial residual gradient W2, which as shown in FIG. 2b is as close as possible to zero degrees to the plane E. Optionally, an intermediate layer 11 can also be created on the friction surfaces 4, 5 before the creation of the wear protection layer 10. Insofar as these lead to thermal stresses in the base body 2, these can also be compensated for in the following step of creating the wear protection layer 10. For this purpose, they need only be taken into account when defining the radial gradient W1.

In absolute values, prefabrication of the base body 2 in practice shows that the inner radius RI along an orthogonal axis to the hub contact surface 7 (in the exemplary embodiment also along the axis A of rotation) should have an offset V to the outer radius RA of between 10 μm and 90 μm, optionally between 30 μm and 70 μm. The gradient W1 for forming this offset does not have to be linear since the thermal stresses do not necessarily lead to a purely angular change. It is thus entirely possible for the friction surfaces 4, 5 according to FIG. 2a to have a curvature over the ring width B to form the radial gradient W1. Typically, the radial gradient W1 should then be formed continuously, rising from the inner radius RI to the outer radius RA. This makes it possible to counteract a more bowl-like deformation caused by the thermal stresses. The non-linearity can therefore result in a particularly high degree of shape accuracy after the creation of the wear protection layer 10. Implementing the radial gradient W1 as a constant angle is somewhat simpler from a technical perspective.

After the creation of the wear protection layer 10, the radial residual gradient W2 is optionally zero degrees, and this is optionally at least substantially linear over the ring width B. However, cases in which the objectives are not achieved in full are also included according to the disclosure. For example, it may be sufficient if, after the creation of the wear protection layer 10, the inner radius RI, along an orthogonal axis to the hub contact surface (in the exemplary embodiment also along the axis A of rotation), has an offset V to the outer radius RA of less than 50 μm, optionally less than 30 μm. Due to the layer thicknesses of the wear protection layer 10, this may be sufficient for a layer thickness of maximum possible homogeneity after smoothing, as illustrated by way of example in FIG. 2c. This objective is in particular also achieved if the radial residual gradient W2 has an opposite sign to the initial radial gradient W1. In relative values, the layer thickness D of the wear protection layers 10 on the friction surfaces 4, 5 after smoothing should have, in each case, a layer thickness variation of less than 50%, optionally of less than 30%. This is in particular the case when the layer thickness variation is defined by dividing the difference between the maximum and minimum layer thickness by the minimum layer thickness.

Optionally, the annular friction surfaces 4, 5 and the hub contact surface 7 may still be oriented at least substantially or completely orthogonally to the axis A of rotation during prefabrication of the base body 2 after casting, and the radial gradient W1 (as illustrated in FIG. 2a) may only be increased, or produced exclusively, by the removal of material in the region of the friction surfaces 4, 5. This makes it possible to use, for example, existing moulds for the method. Removal of material also affords great flexibility with regard to the radial gradient W1 (for example linear or non-linear gradient), in particular by inspecting the radial residual gradient W2 and consequently correcting the radial gradient W1 for further production cycles.

For example, the method may in particular also comprise checking, in particular measuring (for example with a measuring probe), the radial residual gradient W2 of at least one of the two friction surfaces 4, 5 after the creation of the wear protection layer 10, and correcting the radial gradient W1′ during prefabrication of the next base body 2′ in such a way that its friction surfaces 4′, 5′, after the creation of the wear protection layer 10′, have an anticipated residual gradient W2′ which is smaller than that of the checked friction surface 4, 5.

The disclosure is not restricted to any of the embodiments described above and instead can be modified in various ways.

All the features and advantages that are apparent from the claims, the description and the drawing, including structural details, spatial arrangements and method steps, may be essential to the disclosure both individually and in a very wide variety of combinations.

### LIST OF REFERENCE SIGNS

1 Brake disc
2 Base body
3 Friction ring
4 Friction surface
5 Friction surface
6 Hub fastening
7 Hub contact surface
10 Wear protection layer
11 Intermediate layer
A Axis of rotation
B Ring width
E Orthogonal plane
RI Inner radius
RA Outer radius
W1 Radial gradient
W2 Radial residual gradient
V Offset

1. A method for producing a brake disc, comprising:
a) prefabricating a base body with a hub fastening and a friction ring made of metal, wherein the hub fastening has an annular hub contact surface, wherein the friction ring has two opposite annular friction surfaces which run around an axis of rotation of the base body, by
a. casting the base body from metal, and
b. optionally removing material in at least one of the region of the friction surfaces and the region of the hub contact surface;
in such a way that the annular friction surfaces have a radial gradient (W1) with respect to the hub contact surface; and
b) creating a wear protection layer on one or on both of the friction surfaces in such a way that stresses thermally induced in this process deform the annular friction surfaces in such a way that an absolute value of the radial gradient (W1) is reduced to a lower absolute value of a radial residual gradient (W2).

2. The method according to claim 1, wherein, after the creation of the wear protection layer, the radial residual gradient (W2) is substantially or completely zero degrees, so that the friction surfaces are oriented at least substantially or completely orthogonally to the axis of rotation.

3. The method according to claim 1, wherein the friction surfaces each have a ring width (B) with an inner radius (RI) and an outer radius (RA), wherein, during prefabrication of the base body, the radial gradient (W1) of the friction surfaces is formed in such a way that, along an orthogonal axis to the hub contact surface, the inner radius (RI) has an offset (V) to the outer radius (RA), the absolute value of the offset (V) being between 10 μm and 90 μm.

4. The method according to claim 1, wherein the friction surfaces each have a ring width (B) with an inner radius (RI) and an outer radius (RA), wherein, after the creation of the wear protection layer, the radial residual gradient (W2) is formed in such a way that, along an orthogonal axis to the hub contact surface, the inner radius (RI) has an offset (V) to the outer radius (RA), the absolute value of the offset (V) being less than 50 μm.

5. The method according to claim 1, wherein the radial gradient (W1) is a constant angle, or the radial gradient (W1) is continuous and becomes steeper with increasing distance from the axis of rotation.

6. The method according to claim 1, wherein the wear protection layer is created by laser metal deposition.

7. The method according to claim 1, further comprising smoothing the friction surfaces after the creation of the wear protection layer.

8. The method according to claim 7, wherein, after smoothing, the layer thickness (D) of the wear protection layer on one or on both friction surfaces has, in each case, a layer thickness variation of less than 50%.

9. The method according to claim 1, wherein, during prefabrication of the base body after casting, the annular friction surfaces and the hub contact surface are oriented at least substantially or completely orthogonally to the axis of rotation, and the radial gradient (W1) is increased, or produced exclusively, by the removal of material in at least one of: the region of the friction surfaces and the region of the hub contact surface.

10. The method according to claim 1, further comprising checking the radial residual gradient (W2) of at least one of the two friction surfaces after the creation of the wear protection layer, and correcting the radial gradient (W1′) during prefabrication of the next base body in such a way that its friction surfaces, after the creation of the wear protection layer, have an anticipated radial residual gradient (W2′) which is smaller than the radial residual gradient (W2) of the checked friction surface.

11. The method according to claim 1, further comprising creating an intermediate layer on one or both of the friction surfaces before the creation of the wear protection layer.

12. The method according to claim 3, wherein the absolute value of the offset (V) is between 30 μm and 70 μm.

13. The method according to claim 4, wherein the absolute value of the offset (V) is less than 30 μm.

14. The method according to claim 7, wherein, after smoothing, the layer thickness (D) of the wear protection layer on one or on both friction surfaces has, in each case, a layer thickness variation of less than 30%.
